(19) United States
(12) Patent Application Publication
(10) Pub. No.: US 2016/0370597 A1
(43) Pub. Date: Dec. 22, 2016

(54) OPTICAL ELEMENT

(71) Applicant: ARISAWA MFG. CO., LTD., Niigata (JP)

(72) Inventors: Yuichi KAKUBARI, Niigata (JP); Kenichi WATABE, Niigata (JP)

(21) Appl. No.: 15/256,631

(22) Filed: Sep. 5, 2016

Related U.S. Application Data
(63) Continuation of application No. PCT/JP2014/001250, filed on Mar. 6, 2014.

(51) Int. Cl. G02B 27/28; G02B 5/30

(52) U.S. Cl. CPC G02B 27/283; G02B 27/286; G02B 5/3016

(57) ABSTRACT

Conventional optical elements cannot emit circularly polarized light beams obtained by beam separation in the same direction. An optical element includes a polarization splitter element configured to split incoming light into a first circularly polarized light beam and a second circularly polarized light beam that has different handedness than the first circularly polarized light beam, where the polarization splitter element is configured to reflect the first circularly polarized light beam and allow the second circularly polarized light beam to transmit, and a reflector element configured to reflect the first circularly polarized light beam that has been reflected by the polarization splitter element, to proceed in a direction in which the second circularly polarized light beam is allowed to transmit.

The contents of the following International patent application are incorporated herein by reference:
NO. PCT/JP2014/001250 filed on Mar. 6, 2014.

### BACKGROUND

1. Technical Field

The present invention relates to an optical element.

2. Related Art

It is known in the art to split light including a plurality of polarized light beams into a plurality of linearly polarized light beams by reflecting a linearly polarized light beam and allowing a different linearly polarized light beam to transmit (see, for example, Japanese Patent Application Publication No. 2003-167125).

The above-described technique, however, disadvantageously cannot split the light into circularly polarized light beams nor emit the circularly polarized light beams in the same direction.

### SUMMARY

A first aspect of the innovations herein provide an optical element includes a polarization splitter element configured to split incoming light into a first circularly polarized light beam and a second circularly polarized light beam that has different handedness than the first circularly polarized light beam, where the polarization splitter element is configured to reflect the first circularly polarized light beam and allow the second circularly polarized light beam to transmit, and a reflector element configured to reflect the first circularly polarized light beam that has been reflected by the polarization splitter element, to proceed in a direction in which the second circularly polarized light beam is allowed to transmit.

The summary clause does not necessarily describe all necessary features of the embodiments of the present invention. The present invention may also be a sub-combination of features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic view showing a projector apparatus 50 including an optical element 10.

FIG. 2 is a partial cross-sectional view showing the optical element 10.

FIG. 3 shows one of the steps of manufacturing the optical element 10.

FIG. 4 shows one of the steps of manufacturing the optical element 10.

FIG. 5 shows one of the steps of manufacturing the optical element 10.

FIG. 6 shows one of the steps of manufacturing the optical element 10.

FIG. 7 is a partial cross-sectional view showing an optical element 110.

FIG. 8 shows one of the steps of manufacturing the optical element 110.

FIG. 9 shows one of the steps of manufacturing the optical element 110.

FIG. 10 shows one of the steps of manufacturing the optical element 110.

FIG. 11 shows one of the steps of manufacturing the optical element 110.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

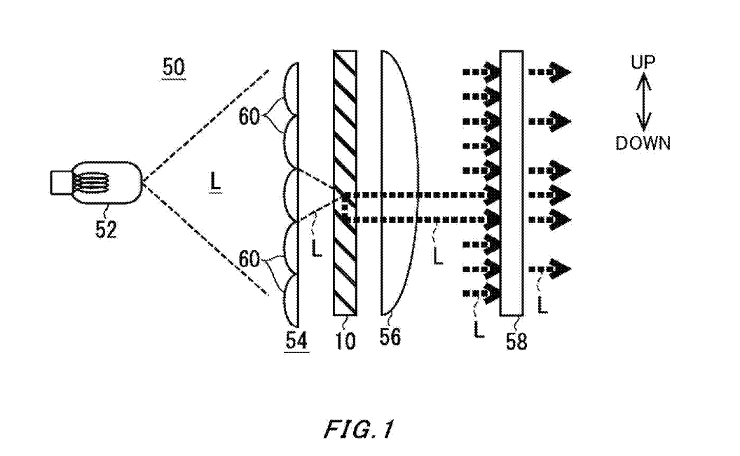

FIG. 1 is a schematic view showing a projector apparatus 50 including an optical element 10. The arrows in FIG. 1 show the vertical or up-and-down direction of the projector apparatus 50. As shown in FIG. 1, the projector apparatus 50 includes a light source 52, a lens array 54, an optical element 10, a lens 56 and a liquid crystal panel 58.

The light source 52 emits non-polarized white light L to the lens array 54. The lens array 54 is located to receive the light emitted from the light source 52. The lens array 54 includes a plurality of light concentrators 60. The light concentrators 60 are provided in the same plane to which the traveling direction of the light L from the light source 52 is normal. The light concentrators 60 are, for example, arranged in matrix. The light concentrators 60 concentrate the light emitted from the light source 52 in a plurality of regions and allow the concentrated light to proceed toward the optical element 10.

The optical element 10 splits the light L concentrated by the light concentrators 60 into a first circularly polarized light beam and a second circularly polarized light beam that has different handedness than the first circularly polarized light beam. The optical element 10 aligns the individual circularly polarized light beams to have the same handedness, then converts the resulting circularly polarized light beams into polarized light beams L aligned in the same direction of polarization, for example, linearly s-polarized light beams, which then proceed toward the lens 56.

The lens 56 concentrates the polarized light beams L aligned by the optical element 10 in the same direction of polarization and allows the concentrated light beams to proceed to the liquid crystal panel 58. The liquid crystal panel 58 allows part of the polarized light beams L concentrated by the lens 56 to transmit and blocks the rest, to create images.

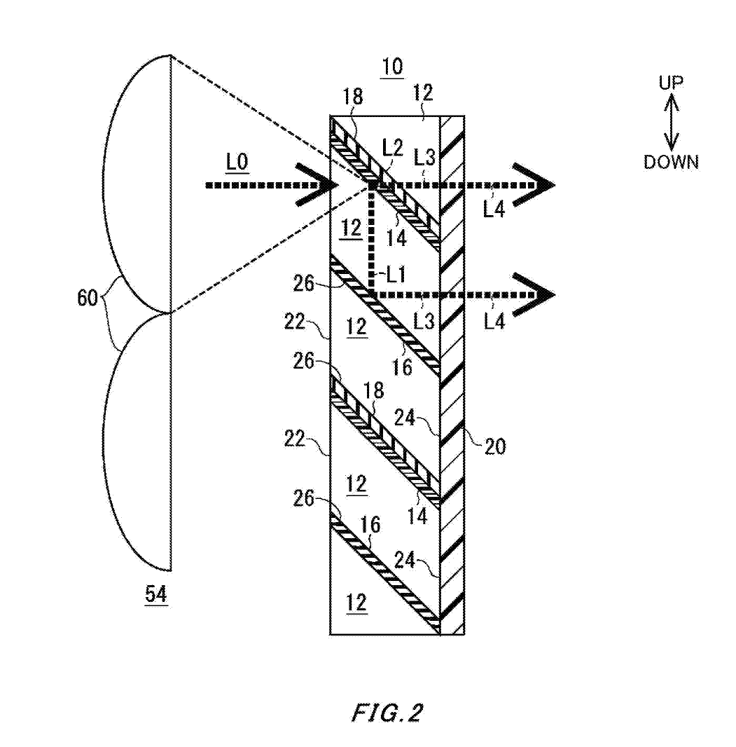

FIG. 2 is a partial cross-sectional view showing the optical element 10. As shown in FIG. 2, the optical element 10 includes a plurality of base materials 12, a plurality of polarization splitter elements 14, a plurality of reflector elements 16, a plurality of first polarization converter elements 18, and a second polarization converter element 20.

The base materials 12 are made of materials that allows light to transmit therethrough. The base materials 12 are isotropic to light. The base materials 12 can be made of triacetylcellulose (TAC), cyclo olefin polymer (COP), cyclo olefin copolymer (COC), which is a copolymer of COP, polycarbonate (PC) and the like. As a TAC film, FUJITAC T80SZ, TD 80 UL and the like available from FUJIFILM Corporation can be employed. As a COP film, ZeonorFilm®ZF14 available from Zeon Corporation can be employed. In order to use a cyclo-olefin-based film, it is preferable to use a film of high toughness due to the brittleness issues. The base materials 12 may be colorless and transparent glass substrates.

The base materials 12 are shaped like a parallelogram in a cross-sectional view, except the top and bottom base materials 12. Specifically speaking, each base material 12 has an entrance surface 22 and an exit surface 24 that are substantially orthogonal to incoming light beams L0. In addition, each base material 12 has a pair of inclined surfaces 26 that are inclined with respect to the entrance surface 22 and the exit surface 24. The inclined surfaces 26 are parallel to each other. The inclined surfaces 26 form an angle of 45°, for example, with respect to the entrance surface 22 and the exit surface 24.

The polarization splitter elements 14 are each formed like a film. The polarization splitter elements 14 are disposed on the inclined surfaces 26 of the base materials 12. Accordingly, the polarization splitter elements 14 are inclined with respect to the direction in which the incoming light beams proceed. For example, the polarization splitter elements 14 are inclined at angle of 45° with respect to the direction in which the incoming light beams proceed.

The polarization splitter elements 14 split the incoming light by reflecting a first circularly polarized light beam L1 and allowing a second circularly polarized light beam L2 that has different handedness than the first circularly polarized light beam L1 to transmit. The first circularly polarized light beam L1 is a right-handed circularly polarized light beam, for example. The second circularly polarized light beam L2 is a left-handed circularly polarized light beam, for example. It should be noted that the first circularly polarized light beam L1 is a left-handed circularly polarized light beam, and the second circularly polarized light beam L2 is a right-handed circularly polarized light beam. The polarization splitter elements 14 contain cholesteric liquid crystals. In a cholesteric liquid crystal film, the rod-like liquid crystal molecules are oriented helically. The helical axis is parallel to the normal direction to the plane of the polarization splitter elements 14. The product of the helical cycle in the liquid crystal molecules and the refractive index of the liquid crystal molecules is set to be substantially equal to the wavelength of the light that can be split into the two circularly polarized light beams by reflection. Here, the light having a wavelength different than the helical cycle transmits through the polarization splitter elements 14.

Specifically speaking, the following expression (1) is established when p denotes the helical cycle in the liquid crystal molecules, n denotes the average refractive index of the liquid crystals and λ denotes the wavelength of the light to be split.

λ=p·n (1)

If the liquid crystals have anisotropic refractive index, light having a range of wavelengths can be split by the reflection. When the magnitude of the range of refractive indices achieved by the anisotropy is denoted as Δn and the magnitude of the range of wavelengths of the light is denoted as Δλ, the following expression (2) is established.

Δλ=p·Δn (2)

Accordingly, if the refractive index of the liquid crystals has the variation Δn caused by the anisotropy, the light that can be split by the polarization splitter element 14 into the two circularly polarized light beams can have a range of wavelengths centered on the wavelength λ, which is expressed by the expression (1), or from (λ−Δλ/2) to (λ|Δλ/2).

If the light enters the optical element 10 at an angle with respect to the helical axis of the liquid crystal molecules, the expression (1) may be transformed into the following expression (3) due to the Bragg condition. Here, α denotes the angle between the incoming light and the helical axis.

λ=p·n·cos α (3)

Considering these expressions, the helical cycle in the liquid crystal molecules (p) is determined by the refractive index of the liquid crystal material (n), the wavelength of the light (λ) and the incident angle of the incoming light (α). The helical cycle of the liquid crystal molecules can be adjusted by controlling the concentration of the chiral agent added in the cholesteric liquid crystals.

The reflector elements 16 are each formed like a film. The reflector elements 16 are disposed on the inclined surfaces 26 of the base materials 12. Accordingly, the reflector elements 16 are inclined with respect to the direction in which the incoming light proceeds. The angle of inclination of the reflector elements 16 is determined in such a manner that the first circularly polarized light beam L1 can be reflected to proceed in the direction in which the second circularly polarized light beam L2 travels. For example, the reflector elements 16 are arranged so as to be substantially parallel to the polarization splitter elements 14. Therefore, in the present embodiment, the reflector elements 16 are inclined at an angle of 45° with respect to the traveling direction of the incoming light.

The reflector elements 16 are made of resins. The reflector elements 16 are made of a cholesteric-liquid-crystal-based material. More specifically, the reflector elements 16 are made of the same resin-based material as the polarization splitter elements 14 are. That is to say, the reflector elements 16 reflect right-handed circularly polarized light and allow left-handed circularly polarized light to transmit, like the polarization splitter elements 14. Accordingly, the reflector elements 16 reflect the first circularly polarized light beam L1 that has been reflected by the polarization splitter elements 14 to proceed in the direction in which the second circularly polarized light beam L2 is allowed to transmit by the polarization splitter elements 14 and travels.

The reflector elements 16 do not change the handedness of the first circularly polarized light beam L1. Accordingly, the handedness of the first circularly polarized light beam L1 remains right-handed even after the first circularly polarized light beam L1 is reflected by the reflector elements 16. Here, the first circularly polarized light beam L1 that has been reflected by the reflector elements 16 will be referred to as a circularly polarized light beam L3.

The first polarization converter elements 18 are provided on the inclined surfaces 26 of the base materials 12. The first polarization converter elements 18 entirely cover the exit surfaces of the polarization splitter elements 14. The first polarization converter elements 18 convert circularly polarized light of particular handedness into circularly polarized light of the reversed handedness. The first polarization converter elements 18 are half wave plates, for example. Specifically speaking, the first polarization converter elements 18 convert the left-handed second circularly polarized light beam L2 into a right-handed circularly polarized light beam. In this manner, the first polarization converter elements 18 change the handedness of the second circularly polarized light bean L2 that has transmitted through the polarization splitter elements 14 to align the handedness of the second circularly polarized light beam L2 with the handedness of the first circularly polarized light beam L1 that has been reflected by the polarization splitter elements 14. Here, the second circularly polarized light beam L2 will be referred to as a circularly polarized light beam L3 after the handedness is changed by the first polarization converter elements 18.

Here, a pair of each polarization splitter element 14 and a corresponding first polarization converter element 18 faces one of the reflector elements 16 with a base material 12 placed therebetween. Each polarization splitter element 14 and a corresponding first polarization converter element 18 are provided on the upper inclined surface 26 of one of the base materials 12, and each reflector element 16 is provided on the same side or the upper inclined surface 26 of an adjacent one of the base materials 12. The pairs of one polarization splitter element 14 and one first polarization converter element 18 alternate with the reflector elements 16. In other words, a plurality of sets of one polarization splitter element 14, one first polarization converter element 18 and one reflector element 16 are periodically arranged in the up-and-down direction.

The second polarization converter element 20 converts, into linearly polarized light beams L4, the circularly polarized light beams L3 having the same handedness achieved by the first polarization converter elements 18. The second polarization converter element 20 converts the circularly polarized light beams L3 into, for example, linearly s-polarized light beams L4. The second polarization converter element 20 is formed like a film. The second polarization converter element 20 is formed to substantially entirely cover the exit surfaces 24 of the base materials 12. The second polarization converter element 20 is formed on the plane, to which the traveling direction of the incoming light is normal. The second polarization converter element 20 is a quarter wave plate.

The light concentrators 60 of the lens array 54 are provided in a one-to-one correspondence with the sets of one polarization splitter element 14, one reflector element 16 and one first polarization converter element 18. The light beams L0 concentrated by the light concentrators 60 enter the polarization splitter elements 14. Here, the light beams concentrated by the light concentrators 60 do not directly enter the first polarization converter elements 18.

The following describes how the above-described optical element 10 behaves.

Non-polarized white light beams L0, which are emitted from the light source 52 and concentrated by the light concentrators 60 of the lens array 54, are incident on the polarization splitter elements 14 of the optical element 10. The polarization splitter elements 14 reflect the right-handed first circularly polarized light beams L1 of the incident light beams toward the reflector elements 16. On the other hand the polarization splitter elements 14 allow the left-handed second circularly polarized light beams L2 of the incident light beams to transmit toward the first polarization converter elements 18.

Configured to reflect right-handed circularly polarized light, the reflector elements 16 reflect the first circularly polarized light beams L1 in the direction parallel to the traveling direction of the incoming light beams L0, in other words, toward the second polarization converter element 20. The first polarization converter elements 18, which are half wave plates, convert the left-handed second circularly polarized light beams L2 into the right-handed circularly polarized light beams L3 and allow the circularly polarized light beams L3 to proceed toward the second polarization converter element 20 without changing the traveling direction. In this manner, the first circularly polarized light beams L1 and the second circularly polarized light beam L2, into which the light beams L0 have been split by the polarization splitter elements 14, are converted to have the same handedness or into the right-handed circularly polarized light beams L3 and also converted to proceed in the direction in which the light beams enter the optical element 10.

The second polarization converter element 20, which is a quarter wave plate, converts the right-handed circularly polarized light beams L3 into linearly polarized light beams, for example, a linearly s-polarized light beams L4 and allows the linearly s-polarized light beams L4 to proceed toward the lens 56. The linearly polarized light beams L4 from the second polarization converter element 20 all have the same direction of polarization. Thus, almost all of the light beams L0 emitted from the light source 52 can be utilized.

As described above, having the polarization splitter elements 14, the optical element 10 can split the incoming light beams L0 into the first circularly polarized light beams L1 and the second circularly polarized light beams L2 of different handedness without blocking any of the incoming light beams L0. Having the reflector elements 16, the optical element 10 can emit the separated first circularly polarized light beams L1 and the second circularly polarized light beams L2 in the same direction. Furthermore, having the first polarization converter elements 18, the optical element 10 can convert the first circularly polarized light beams L1 and the second circularly polarized light beams L2, which are obtained by the beam separation, into the circularly polarized light beams L3 all of which have the same handedness. Having the second polarization converter element 20, the optical element 10 can convert the circularly polarized light beams L3 having the same handedness into the linearly polarized light beams L4 having the same direction of polarization and emit the linearly polarized light beams L4. Thus, the optical element 10 can utilize the light beams L0 from the light source 52 more efficiently.

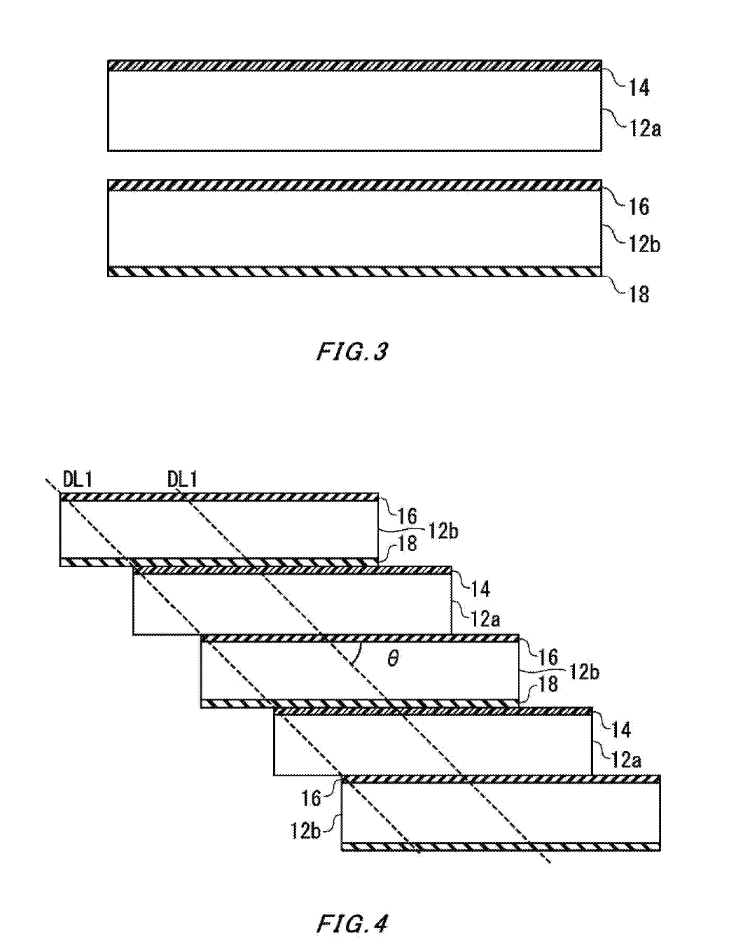

The following describes how to manufacture the above-described optical element 10. FIGS. 3, 4, 5 and 6 show the steps of manufacturing the optical element 10.

As shown in FIG. 3, in one of the steps of manufacturing the optical element 10, a polarization splitter element 14 is formed by application on one of the surfaces of a plate-like base material 12a. A reflector element 16 is formed by application on one of the surfaces of another plate-like base material 12b. It should be noted that the base materials 12a and 12b are the some as the base materials 12 but distinguished from each other in order to provide clear description of the manufacturing method. The polarization splitter element 14 and the reflector element 16 can be each formed by applying an alignment film and orienting the molecules of the alignment film, and then applying and curing a cholesteric liquid crystal film. In addition, a first polarization converter element 18 is formed on the other of the surfaces of the base material 12b. The first polarization converter element 18 may be formed in accordance with the known method of manufacturing a half wave plate. For example, the first polarization converter element 18 can be formed by applying a photo-alignment film and orienting the molecules of the photo-alignment film and then applying and curing nematic liquid crystals. Alternatively, the first polarization converter element 18 may be formed by attaching a completed half wave plate film on the other of the surfaces of the base material 12b. Note that the order of the steps of manufacturing the polarization splitter element 14, the reflector element 16 and the first polarization converter element 18 can be varied as appropriate. Furthermore, the polarization splitter element 14 and the reflector element 16 are made of the same cholesteric liquid crystals. In this case, cholesteric liquid crystals, which are to provide both the polarization splitter element 14 and the reflector element 16, are formed on one of the surfaces of every base material 12. After this, the first polarization converter element 18 may be formed on the other of the surfaces of half of the base materials 12.

Subsequently, as shown in FIG. 4, the base materials 12a having the polarization splitter element 14 formed thereon and the base materials 12b having the reflector element 16 and the first polarization converter element 18 formed thereon are alternately stacked on one another. Here, one base material 12a and one base material 12b are stacked together in such an orientation that the polarization splitter element 14 is in contact with the first polarization converter element 18. Furthermore, when stacked one another, the base materials 12a and 12b are preferably shifted in the same direction in such a manner that the dotted line DL1 shown in FIG. 4, which connects the corresponding corners of the base materials 12a and 12b, is inclined with respect to the surfaces of the base materials 12a and 12b. In this manner, more optical elements 10 can be manufactured from the same number of base materials 12a and 12b. Here, the angle θ of inclination of the dotted line DL1 with respect to the surfaces of the base materials 12a and 12b is equal to the angle of inclination of the polarization splitter elements 14 with respect to the incoming direction of the light beams L0 incident on the completed optical element 10.

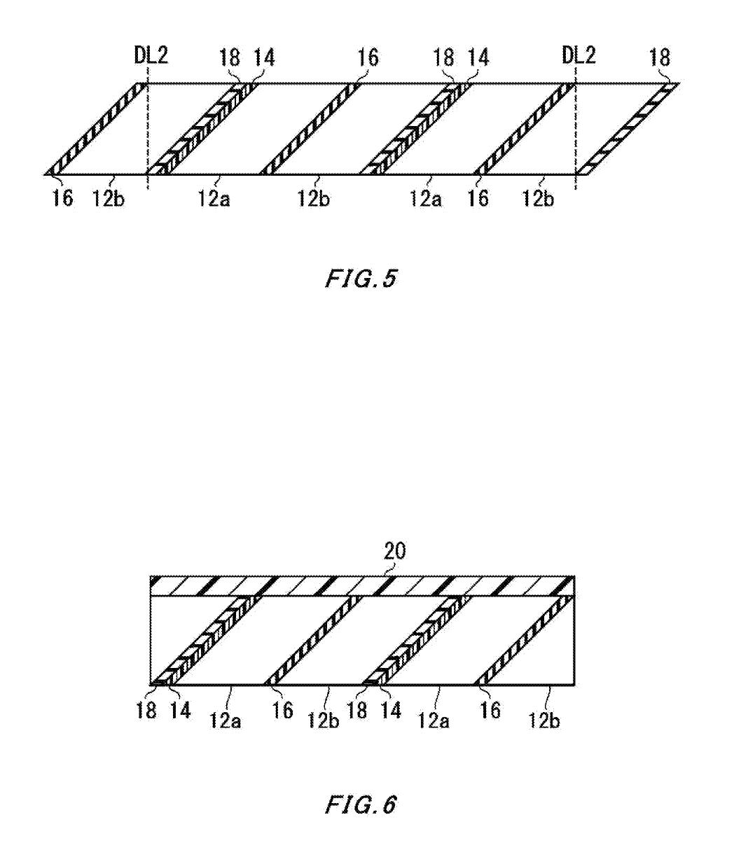

Subsequently, the base materials 12a and 12b stacked along the dotted line DL1 shown in FIG. 4 are cut into the structures shown in FIG. 5. Furthermore, the base materials 12a and 12b are subjected to cutting along the dotted lines DL2 shown in FIG. 5 so that the structures shown in FIG. 6 are obtained. On the exit surfaces of the base materials 12a and 12b of these structures, the second polarization converter element 20 is formed. In this manner, the optical element 10 is completed.

According to the above-described method of manufacturing the optical element 10, the polarization splitter elements 14 and the reflector elements 16 are made of cholesteric liquid crystals. This makes it possible to form the polarization splitter elements 14 and the reflector elements 16 in the same manufacturing or applying step, which can improve the productivity. The productivity can be improved in particular by shortening the time required to form the reflector elements 16, when compared with the case where the reflector elements 16 are formed as a metal film or the like and vapor deposition is thus required. In addition, the reflector elements 16 can be formed on the base materials 12 having a larger area than when the reflector elements 16 are formed as a metal film using a vapor deposition apparatus that often has a circular-dome-shaped chamber. Therefore, the completed optical elements 10 can have a larger area and small optical elements 10 can be produced more efficiently. Furthermore, if the base materials 12 are flexible, the completed optical element 10 can be flexible.

The following describes an alternative embodiment to the above-described optical element.

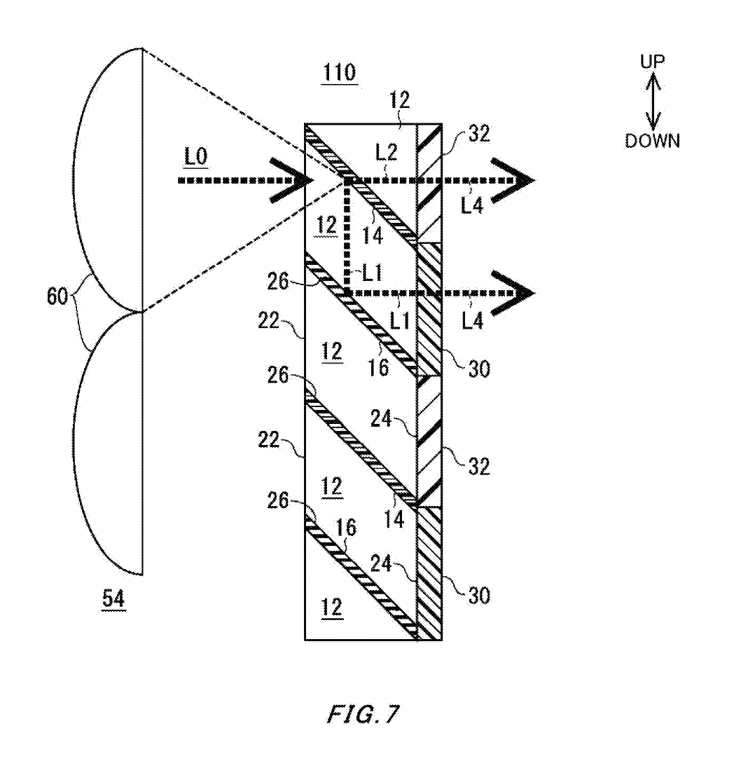

FIG. 7 is a partial cross-sectional view showing an optical element 110. As shown in FIG. 7, the optical element 110 includes base materials 12, polarization splitter elements 14, reflector elements 16, first polarization converter units 30 and second polarization converter units 32. The optical element 110 is different from the optical element 10 in that the first polarization converter elements 18 are not provided on the polarization splitter elements 14.

The first polarization converter units 30 are provided on exit surfaces 24 of the base materials 12. The first polarization converter units 30 are located to receive the light emitted from the reflector elements 16. Accordingly, the first polarization converter units 30 receive the first circularly polarized light beams L1 reflected by the reflector elements 16. The first circularly polarized light beams L1 are right-handed. The first polarization converter units 30 convert the first circularly polarized light beams L1 that are incident thereon after being reflected by the reflector elements 16 into the linearly polarized light beams L4 and allow the linearly polarized light beams L4 to proceed. The first polarization converter units 30 are quarter wave plates.

The second polarization converter units 32 are provided on the exit surfaces 24 of the base materials 12. The second polarization converter units 32 are located to receive the light emitted from the polarization splitter elements 14. In other words, the second polarization converter units 32 are differently positioned than the first polarization converter units 30 on the exit surfaces 24 of the base materials 12. The first polarization converter units 30 and the second polarization converter units 32 are alternately arranged on the exit surfaces 24, which are in the same plane. The second polarization converter units 32 receive the second circularly polarized light beams L2 that have transmitted through the polarization splitter elements 14. The second circularly polarized light beams L2 have different handedness than the first circularly polarized light beams L1, i.e., are left-handed. The second polarization converter units 32 convert the second circularly polarized light beams L2 that are incident thereon after having transmitted through the polarization splitter elements 14 into the linearly polarized light beams L4 and allow the linearly polarized light beams L4 to proceed. The second polarization converter units 32 are quarter wave plates.

Here, the optic axis of the second polarization converter units 32 is orthogonal to the optic axis of the first polarization convener units 30. As used herein, the term “optic axis” denotes the slow or fast axis. The direction of polarization of the linearly polarized light beams L4 from the second polarization converter units 32, which receive the left-handed second circularly polarized light beams L2, is the same as the direction of polarization of the linearly polarized light beams L4 from the first polarization converter units 30, which receive the right-handed first circularly polarized light beams L1.

The following describes how above-described optical element 110 behaves.

Non-polarized white light beams L0, which are emitted from the light source 52 and concentrated by the light concentrators 60 of the lens array 54, are incident on the polarization splitter elements 14 of the optical element 110. The polarization splitter elements 14 reflect the right-handed first circularly polarized light beams L1 of the incident light beams toward the reflector elements 16. In addition, the polarization splitter elements 14 allow the left-handed second circularly polarized light beams L2 of the incident light beams to transmit.

Configured to reflect right-handed circularly polarized light, the reflector elements 16 reflect the first circularly polarized light beams L1 in the direction parallel to the traveling direction of the incoming light beams L0, in other words, toward the first polarization converter units 30. The first polarization converter units 30 convert the incoming first circularly polarized light beams L1 into the linearly polarized light beams L4 and allow the linearly polarized light beams L4 to proceed. The second polarization converter units 32 convert the second circularly polarized light beams L2 that have transmitted through the polarization splitter elements 14 into the linearly polarized light beams L4 that have the same direction of polarization as the linearly polarized light beams L4 from the first polarization converter unit 30, and allow the linearly polarized light beams L4 to proceed. The first polarization converter units 30 and the second polarization converter units 32 allow the resulting linearly polarized light beams L4 to proceed to the liquid crystal panel 58 via the lens 56.

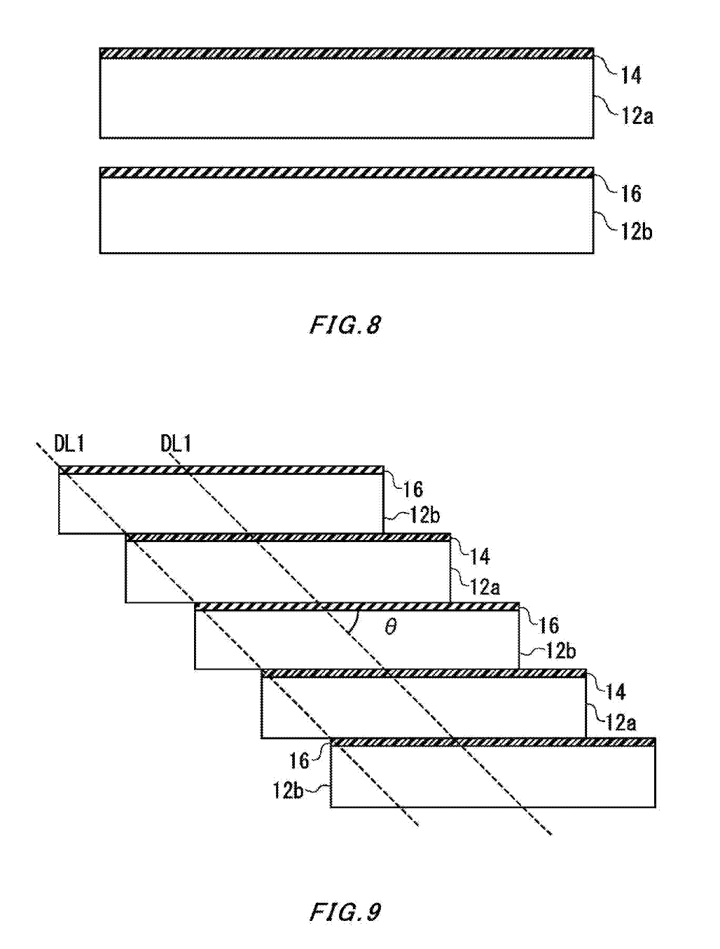

The following describes how to manufacture the above-described optical element 110. FIGS. 8, 9, 10 and 11 show the steps of manufacturing the optical element 110.

As shown in FIG. 8, in one of the steps of manufacturing the optical element 110, a polarization splitter element 14 is formed by application on one of the surfaces of a plate-like base material 12a. A reflector element 16 is formed by application on one of the surfaces of another plate-like base material 12b. The polarization splitter element 14 and the reflector element 16 can be each formed by forming an alignment film in which the molecule orientations are aligned and then forming a cholesteric liquid crystal film. The polarization splitter element 14 and the reflector element 16 are made of the same cholesteric liquid crystals.

Subsequently, as shown in FIG. 9, the base materials 12a having the polarization splitter element 14 formed thereon and the base materials 12b having the reflector element 16 formed thereon are alternately stacked on one another. When stacked on one another, the base materials 12a and 12b arc preferably shifted in the same direction.

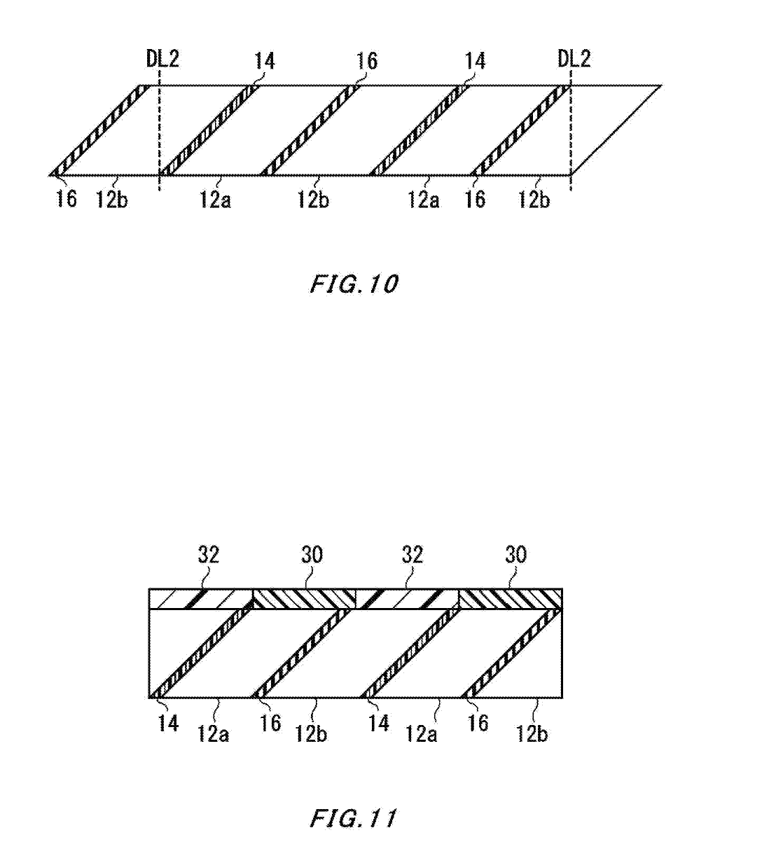

Subsequently, the base materials 12a and 12b stacked along the dotted line DL1 shown in FIG. 9 are cut into the structures shown in FIG. 10. Furthermore, the base materials 12a and 12b are subjected to cutting along the dotted lines DL2 shown in FIG. 10 so that the structures shown in FIG. 11 are obtained. On the exit surfaces of the base materials 12a and 12b of these structures, the first polarization converter units 30 and the second polarization converter units 32 are formed. Specifically speaking, an alignment film is formed on the exit surfaces of the base materials 12a and 12b. In the formed alignment film, the alignment film in the region that is positioned to receive light from the reflector elements 16 is oriented to be orthogonal to the alignment film in the region that is positioned to receive the light from the polarization splitter elements 14. After this, nematic liquid crystals are formed on the alignment film and the liquid crystal molecules are oriented along the alignment film. In this way, the first polarization converter units 30 and the second polarization converter units 32 are patterned. Alternatively, a quarter wave plate in which the first polarization converter units 30 and the second polarization converter units 32 have been patterned may be attached to the exit surfaces of the base materials 12a and 12b. In this manner, the optical element 110 is completed.

The shapes, arrangements, numerical values such as the number of the components, materials and the like mentioned in relation to the components of the above-described embodiments may be changed as appropriate. Furthermore, some of the features of an embodiment may be combined with some of the features of another embodiment.

For example, if light having a plurality of wavelengths is split into two circularly polarized light beams, the number of the polarization splitter elements 14 stacked on one another may be equal to the number of the resulting light beams of different wavelengths into which the light is split. For example, if light is split into red, green and blue light beams, a polarization splitter element 14 in which cholesteric liquid crystal molecules are helically arranged with the cycle equal to the red light wavelength, a polarization splitter element 14 in which cholesteric liquid crystal molecules are helically arranged with the cycle equal to the green light wavelength and a polarization splitter element 14 in which cholesteric liquid crystal molecules are helically arranged with the cycle equal to the blue light wavelength may be stacked on one another. Note that, if Δn has a large value in the above-mentioned expression (2), a single layer-like polarization splitter element 14 can be sufficient to split light containing a plurality of colors into two circularly polarized light beams.

In the above-described embodiments, the optical elements 10, 110 are utilized in the projector apparatus 50, for example. The optical elements 10, 110, however, may be utilized in other apparatuses. For example, the optical elements 10, 110 may be utilized in a backlight provided in a liquid crystal display device to allow the backlight to emit a single type of linearly polarized light beams. Alternatively, the optical elements 10, 110 may be utilized in tm optical pickup.

The optical element 10 and 110 may be utilized in a 3D image display apparatus that requires different polarized light beams for left and right eyes. In this case, the first polarization converter elements 18 are omitted from the optical element 10. By doing so, the optical element 10 can emit linearly polarized light beams orthogonal to each other as the light beams to form the right-eye and left-eye images. Alternatively, the first polarization converter elements 18 and the second polarization converter elements 20 may be omitted from the optical element 10. By doing so, the optical element 10 can emit right-handed and left-handed circularly polarized light beams as the light beams to form the right-eye and left-eye images. Alternatively, the first polarization converter units 30 and the second polarization converter units 32 may be omitted from the optical element 110. By doing so, the optical element 110 can emit right-handed and left-handed circularly polarized light beams as the light beams to form the right-eye and left-eye images.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### DESCRIPTION OF REFERENCE NUMERALS

10 optical element

12 base material

14 polarization splitter element

16 reflector element

18 first polarization converter element

20 second polarization converter element

22 entrance surface

24 exit surface

26 inclined surface

30 first polarization converter unit

32 second polarization converter unit

50 projector apparatus

52 light source

54 lens array

56 lens

58 liquid crystal panel

60 light concentrator

110 optical element

What is claimed is:

1. An optical element comprising:
a polarization splitter element configured to split incoming light into a first circularly polarized light beam and a second circularly polarized light beam that has different handedness than the first circularly polarized light beam, the polarization splitter element being configured to reflect the first circularly polarized light beam and allow the second circularly polarized light beam to transmit; and
a reflector element configured to reflect the first circularly polarized light beam that has been reflected by the polarization splitter element, to proceed in a direction in which the second circularly polarized light beam is allowed to transmit.

2. The optical element as set forth in claim 1, further comprising:
a first polarization converter element configured to control the first circularly polarized light beam that has been reflected by the polarization splitter element and the second circularly polarized light beam that has transmitted through the polarization splitter element to have same handedness, and
a second polarization converter element configured to convert, into linearly polarized light beams, the first and second linearly polarized light beams controlled by the first polarization converter element to have same handedness.

3. The optical element as set forth in claim 2, wherein
the first polarization converter element is provided on an exit surface of the polarization splitter element.

4. The optical element as set forth in claim 1, further comprising:
a first polarization converter unit configured to convert, into a given linearly polarized light beam, the first circularly polarized light beam that has been reflected by the reflector element; and
a second polarization converter unit configured to convert, into a linearly polarized light beam that has a same direction of polarization as the given linearly polarized light beam, the second circularly polarized light beam that has transmitted through the polarization splitter element.

5. The optical element as set firth in claim 4, wherein
the first polarization converter unit and the second polarization converter unit are quarter wave plates that are alternately arranged in a same plane, and
an optic axis of the first polarization converter unit is orthogonal to an optic axis of the second polarization converter unit.

6. The optical element as set forth in claim 1, wherein
the polarization splitter element is inclined with respect to the incoming light.

7. The optical element as set forth in claim 1, wherein
the reflector element is parallel to the polarization splitter element.

8. The optical element as set forth in claim 1, wherein
the reflector element is made of a resin.

9. The optical element as set forth in claim 1, wherein
the reflector element is made of a same material as the polarization splitter element.

10. The optical element as set forth in claim 10, wherein
the polarization splitter element contains a cholesteric liquid crystal.

11. The optical element as set forth in claim 10, wherein
the reflector element contains a same cholesteric liquid crystal as the polarization splitter element does.
